(19) United States
(12) Patent Application Publication
(10) Pub. No.: US 2026/0321190 A1
(43) Pub. Date: Oct. 15, 2026

(54) DISPLAY DEVICE AND METHOD OF DRIVING DISPLAY DEVICE

(71) Applicants: CHENGDU BOE OPTOELECTRONICS TECHNOLOGY CO., LTD., Chengdu (CN); BOE TECHNOLOGY GROUP CO., LTD., Beijing (CN)

(72) Inventors: Qi Liu, Beijing (CN); Miao Liu, Beijing (CN); Yong Yu, Beijing (CN); Xiaoxia Huang, Beijing (CN)

(21) Appl. No.: 18/995,123

(22) PCT Filed: Nov. 30, 2023
(86) PCT No.: PCT/CN2023/135464

§ 371 Date: Jan. 15, 2025

(51) Int. Cl. G09G 3/32

(52) U.S. Cl. CPC G09G 3/32; G09G 2300/0819; G09G 2300/0842; G09G 2300/0861; G09G 2310/06; G09G 2310/08; G09G 2320/0233; G09G 2320/0626; G09G 2330/021; G09G 2340/0435

(57) ABSTRACT

A display device and a driving method are provided. A driving circuit of the display device is configured to when displaying at a first frequency, generate a driving signal for each frame as a refresh frame, and apply the driving signal and a data signal to sub-pixels; and when displaying at a second frequency, generate driving signals for a refresh frame and N−1 hold frames in each group of N consecutive frames, and apply the driving signals to the sub-pixels, where N is a ratio of the first frequency to the second frequency, which is an integer greater than 1. The driving circuit may further adjust the driving signal for each of 1st to nth hold frames relative to the driving signal for the refresh frame in the next group of N consecutive frames, in response to receiving an instruction of frequency switching, where 1≤n≤N−1.

### CROSS REFERENCE TO RELATED APPLICATION(S)

This application is a Section 371 National Stage Application of International Application No. PCT/CN2023/135464, filed on Nov. 30, 2023, entitled “DISPLAY DEVICE AND METHOD OF DRIVING DISPLAY DEVICE”, which is incorporated herein by reference in its entirety.

### TECHNICAL FIELD

The present disclosure relates to a field of display technology, in particular to a display device and a method of driving a display device.

### BACKGROUND

With a development of technology, some display devices is capable of displaying at multiple frequencies and may switch between different frequencies as desired. For example, in practical applications, when the finger touches or refreshes the screen, the frequency will be switched to high frequency, and when the finger has not touched for a period of time and no screen refresh occurs, it will be switched to low frequency. This may save power consumption to a maximum extent. However, frequency switching may lead to inconsistent display brightness before and after switching. For example, when switching between frequencies, low-temperature polycrystalline oxide (LTPO) display devices, especially LTPO 2.0 display devices, may experience transient slight brightening or dimming, and then steady-state brightness, which affects the visual effect.

### SUMMARY

Embodiments of the present disclosure provide an electronic device and a method of driving an electronic device.

According to an aspect of the present disclosure, a display device is provided, including: a plurality of sub-pixels arranged in an array including rows and columns; a driving circuit connected to the plurality of sub-pixels, where the driving circuit is configured to: in a case of displaying at a first frequency, take each frame as a refresh frame, generate a driving signal for the refresh frame, and apply the generated driving signal for the refresh frame and a data signal to the plurality of sub-pixels of the display device, so that the plurality of sub-pixels receive the data signal and emit light, under control of the driving signal for the refresh frame; and in a case of displaying at a second frequency, take N consecutive frames comprising a refresh frame and N−1 hold frames as a group, generate, for each group, a driving signal for the refresh frame in the group and a driving signal for each of the N−1 hold frames in the group, and apply the generated driving signal for the refresh frame and the generated driving signal for each of the hold frames to the plurality of sub-pixels, so that the plurality of sub-pixels receive the data signal and emit light under control of the driving signal for the refresh frame, and maintain the received data signal and emit light under control of the driving signal for each of the hold frames, where N is a ratio of the first frequency to the second frequency, and N is an integer greater than 1; where the driving circuit is further configured to adjust the driving signal for each of 1^{st} to n^{th} hold frames in a next group of N consecutive frames relative to the driving signal for the refresh frame in the next group of N consecutive frames, in response to receiving an instruction of switching from the first frequency to the second frequency, where 1≤n≤N−1.

For example, the driving circuit is configured to adjust the driving signal for each of the 1^{st} to n^{th} hold frames by: adjusting the driving signal for each of the 1^{st} to n^{th} hold frames according to a current display brightness value of the display device by a factor, where the larger the display brightness value, the greater the factor.

For example, the driving circuit is configured to adjust the driving signal for each of the 1^{st} to n^{th} hold frames by: adjusting the driving signal for each of the 1^{st} to n^{th} hold frames by a factor, such that the factor by which the driving signal for an n1^{th} hold frame is adjusted is greater than the factor by which the driving signal for an n2^{th} hold frame is adjusted, where 1≤n1≤n2≤n.

For example, the driving signal includes at least one of a light emitting control signal, a first initial voltage, a second initial voltage, a power supply voltage and a reference voltage, where the light emitting control signal is configured to control the sub-pixel to emit light, the first initial voltage is configured to initialize a voltage of a first electrode of a light emitting element of the sub-pixel, the second initial voltage is configured to initialize a voltage of an input terminal of a driving transistor of the sub-pixel for driving the light emitting element, and the power supply voltage and the reference voltage are configured to supply power to the sub-pixel.

For example, the driving signal includes a light emitting control signal, and the driving circuit is configured to adjust the driving signal for each of the 1^{st} to n^{th} hold frames by: adjusting a waveform parameter of the light emitting control signal for each of the 1^{st} to n^{th} hold frames relative to a waveform parameter of the light emitting control signal for the refresh frame, so that the waveform parameter of the light emitting control signal for each of the 1^{st} to n^{th} hold frames is adjusted to be smaller than the waveform parameter of the light emitting control signal for the refresh frame, where the waveform parameter includes at least one of an effective level duration and an amplitude.

For example, in a case that the display brightness value is in a range of 200 nits to 900 nits, the effective level duration of the light emitting control signal for the hold frame is adjusted by a factor of 4 to 12 rows of sub-pixels or a factor of 4 to 12 pulses.

For example, in the case that the display brightness value is in a range of 200 nits to 900 nits, the effective level duration of the light emitting control signal for the first hold frame is adjusted by a factor of 8 to 12 rows of sub-pixels or a factor of 8 to 12 pulses, and the effective level duration of the light emitting control signal for the second hold frame is adjusted by a factor of 4 to 8 rows of sub-pixels or a factor of 4 to 8 pulses.

For example, in a case that the display brightness value is in a range of 10 nits to 200 nits, the effective level duration of the light emitting control signal for the hold frame is adjusted by a factor of 4 to 8 rows of sub-pixels or a factor of 4 to 8 pulses.

For example, in the case that the display brightness value is in a range of 10 nits to 200 nits, the effective level duration of the light emitting control signal for the first hold frame is adjusted by a factor of 4 to 8 rows of sub-pixels or a factor of 4 to 8 pulses, and the effective level duration of the light emitting control signal for the second hold frame is adjusted by a factor of 0 to 4 rows of sub-pixels or a factor of 0 to 4 pulses.

For example, the driving signal includes a first initial voltage, and the driving circuit is configured to adjust the driving signal for each of the 1^{st} to n^{th} hold frames by: adjusting the first initial voltage for an (N−1)^{th} hold frame among the N−1 hold frames, so that the first initial voltage for the (N−1)^{th} hold frame is positively biased relative to a first initial voltage for the refresh frame; and adjusting the first initial voltage for each of the 1^{st} to n^{th} hold frames among the N−1 hold frames, so that the first initial voltage for each of the 1^{st} to n^{th} hold frames is positively biased relative to the first initial voltage for the (N−1)^{th} hold frame.

For example, the driving signal includes the second initial voltage, and the driving circuit is configured to adjust the driving signal for each of the 1^{st} to n^{th} hold frames by: adjusting the second initial voltage for an (N−1)^{th} hold frame among the N−1 hold frames, so that the second initial voltage for the (N−1)^{th} hold frame is positively biased relative to the second initial voltage for the refresh frame; and adjusting the second initial voltage for each of the 1^{st} to n^{th} hold frames among the N−1 hold frames, so that the second initial voltage for each of the 1^{st} to n^{th} hold frames is negatively biased relative to the second initial voltage for the (N−1)^{th} hold frame.

For example, the driving signal includes at least one of the power supply voltage and the reference voltage, and the driving circuit is configured to adjust the driving signal for each of the 1 st to n^{th} hold frames by: adjusting at least one of the power supply voltage and the reference voltage for each of the 1^{st} to n^{th} hold frames, so that an absolute difference between the power supply voltage and the reference voltage for each of the 1^{st} to n^{th} hold frames is less than an absolute difference between the power supply voltage and the reference voltage for the refresh frame.

For example, the driving circuit is configured to adjust the driving signal for each of the 1 st to n^{th} hold frames relative to the driving signal for the refresh frame by: equally adjusting the power supply voltage and the reference voltage for each of the 1^{st} to n^{th} hold frames, so that the factor by which the absolute difference between the power supply voltage and the reference voltage is adjusted is twice the factor by which the power supply voltage and the reference voltage are adjusted.

For example, in a case of N=2, n=1; and in a case that N is greater than 2, n=2.

For example, the driving circuit is further configured to adjust the driving signal for next one or more refresh frames relative to the driving signal for the last hold frame in a current group of the N consecutive frames, in response to receiving an instruction of switching from the second frequency to the first frequency.

For example, the driving signal includes at least one of a light emitting control signal, a first initial voltage, a second initial voltage, a power supply voltage and a reference voltage, and the driving circuit is configured to adjust the driving signal for the next one or more refresh frames by at least one of: adjusting an effective level duration of the light emitting control signal for the next one or more refresh frames, so that the effective level duration of the light emitting control signal for the refresh frame is greater than the effective level duration of the light emitting control signal for the hold frame; adjusting the first initial voltage for the next one or more refresh frames, so that the first initial voltage for the next one or more refresh frames is negatively biased relative to the first initial voltage for the hold frame; adjusting the second initial voltage for the next one or more refresh frames, so that the second initial voltage for the next one or more refresh frames is positively biased relative to the second initial voltage for the hold frame; and adjusting at least one of the power supply signal and the reference signal for the next one or more refresh frames, so that an absolute difference between the power supply signal and the reference signal for the next one or more refresh frames is greater than an absolute difference between the power supply signal and the reference signal for the hold frame.

For example, the driving circuit includes: a gate driving circuit connected to the plurality of sub-pixels, where the gate driving circuit is configured to generate a gate driving signal and a light emitting control signal; and a driving control circuit connected to the gate driving circuit and the plurality of sub-pixels, where the driving control circuit is configured to control the gate driving circuit to generate the gate driving signal and the light emitting control signal, apply the data signal to the plurality of sub-pixels, and adjust the light emitting control signal.

For example, the driving control circuit is further configured to provide a first initial voltage and/or a second initial voltage, and adjust the first initial voltage and/or the second initial voltage.

For example, the driving circuit further includes a power supply circuit for providing a power supply voltage and a reference voltage to the sub-pixel, and the driving control circuit is further configured to control the power supply circuit to adjust at least one of the power supply voltage and the reference voltage.

For example, the sub-pixel includes a pixel driving circuit and a light emitting element, and the pixel driving circuit includes: a driving sub-circuit including a control terminal, an input terminal and an output terminal; a storage sub-circuit connected between the control terminal of the driving sub-circuit and a power supply signal terminal for receiving a power supply voltage; an input sub-circuit connected to the input terminal of the driving sub-circuit, where the input sub-circuit is configured to provide a data signal to the input terminal of the driving sub-circuit under control of a first gate driving signal; an input control sub-circuit connected between the output terminal of the driving sub-circuit and the control terminal of the driving sub-circuit, and where the input control sub-circuit is configured to electrically connect the output terminal of the driving sub-circuit to the control terminal of the driving sub-circuit under control of a second gate driving signal; a light emitting control sub-circuit connected between the driving sub-circuit and the power supply signal terminal, and between the driving sub-circuit and the light emitting element, where the light emitting control sub-circuit is configured to conduct a path from the power supply signal terminal to the light emitting element through the driving sub-circuit under control of the light emitting control signal; and an initialization sub-circuit connected to the input terminal of the driving sub-circuit, the output terminal of the driving sub-circuit and a first electrode of the light emitting element, where the initialization sub-circuit is configured to initialize a voltage at each of the input terminal of the driving sub-circuit, the output terminal of the driving sub-circuit and the first electrode of the light emitting element, where a second electrode of the light emitting element is connected to a reference signal terminal for receiving a reference voltage.

For example, the driving sub-circuit includes a driving transistor, a gate of the driving transistor serves as the control terminal of the driving sub-circuit, a first electrode of the driving transistor serves as the input terminal of the driving sub-circuit, and a second electrode of the driving transistor serves as the output terminal of the driving sub-circuit.

For example, the storage sub-circuit includes a capacitor, a first electrode of the capacitor is connected to the control terminal of the driving sub-circuit, and a second electrode of the storage sub-circuit is connected to the power supply signal terminal.

For example, the input sub-circuit includes a first transistor, a gate of the first transistor is configured to receive a first gate driving signal, a first electrode of the first transistor is configured to receive the data signal, and a second electrode of the first transistor is connected to the input terminal of the driving sub-circuit; and the input control sub-circuit includes a second transistor, a gate of the second transistor is configured to receive a second gate driving signal, a first electrode of the second transistor is connected to the output terminal of the driving sub-circuit, and a second electrode of the second transistor is connected to the control terminal of the driving sub-circuit.

For example, the light emitting control sub-circuit includes a third transistor and a fourth transistor, a gate of the third transistor is configured to receive a light emitting control signal, a first electrode of the third transistor is connected to the power supply signal terminal, and a second electrode of the third transistor is connected to the input terminal of the driving sub-circuit; and a gate of the fourth transistor is configured to receive a light emitting control signal, a first electrode of the fourth transistor is connected to the output terminal of the driving sub-circuit, and a second electrode of the fourth transistor is connected to the first electrode of the light emitting element.

For example, the initialization sub-circuit includes a fifth transistor, a sixth transistor and a seventh transistor, a gate of the fifth transistor is configured to receive a first reset signal, a first electrode of the fifth transistor is configured to receive a first initial voltage, and a second electrode of the fifth transistor is connected to the first electrode of the light emitting element; a gate of the sixth transistor is configured to receive the first reset signal, a first electrode of the sixth transistor is configured to receive a second initial voltage, and a second electrode of the sixth transistor is connected to the input terminal of the driving sub-circuit; and a gate of the seventh transistor is configured to receive a second reset signal, a first electrode of the seventh transistor is configured to receive a third initial voltage, and a second electrode of the seventh transistor is connected to the output terminal of the driving sub-circuit.

According to another aspect of the present disclosure, a method of driving a display device is further provided, including: in a case of displaying at a first frequency, taking each frame as a refresh frame, generating a driving signal for the refresh frame, and applying the generated driving signal for the refresh frame and a data signal to a plurality of sub-pixels of the display device, so that the plurality of sub-pixels receive the data signal and emit light, under control of the driving signal for the refresh frame; and in a case of displaying at a second frequency, taking N consecutive frames comprising a refresh frame and N−1 hold frames as a group, generating, for each group, a driving signal for the refresh frame in the group and a driving signal for each of N−1 hold frames in the group, and applying the generated driving signal for the refresh frame and the generated driving signal for each of the hold frames to the plurality of sub-pixels, so that the plurality of sub-pixels receive the data signal and emit light under control of the driving signal for the refresh frame, and maintain the received data signal and emit light under control of the driving signal for each of the hold frames, where N is a ratio of the first frequency to the second frequency, and N is an integer greater than 1; where the method further includes: adjusting the driving signal for each of 1^{st} to n^{th} hold frames in a next group of N consecutive frame relative to the driving signal for the refresh frame in the next group of N consecutive frames, in response to receiving an instruction of switching from the first frequency to the second frequency, where 1≤n≤N−1.

For example, the adjusting the driving signal for each of 1^{st} to n^{th} hold frames in the next group of N consecutive frames relative to the driving signal for the refresh frame in the next group of N consecutive frames includes: adjusting the driving signal for each of the 1^{st} to n^{th} hold frames according to a current display brightness value of the display device by a factor, where the larger the display brightness value, the greater the factor.

For example, the adjusting the driving signal for each of 1^{st} to n^{th} hold frames in the next group of N consecutive frames relative to the driving signal for the refresh frame in the next group of N consecutive frames includes: adjusting the driving signal for each of the 1^{st} to n^{th} hold frames such that the factor by which the driving signal for an n1^{th} hold frame is adjusted is greater than the factor by which the driving signal for an n2^{th} hold frame is adjusted, where 1≤n1≤n2≤n.

For example, the driving signal includes at least one of a light emitting control signal, a first initial voltage, a second initial voltage, a power supply voltage and a reference voltage, where the light emitting control signal is configured to control the sub-pixel to emit light, the first initial voltage is configured to initialize a voltage of a first electrode of a light emitting element of the sub-pixel, the second initial voltage is configured to initialize a voltage of an input terminal of a driving transistor of the sub-pixel for driving the light emitting element, and the power supply voltage and the reference voltage are configured to supply power to the sub-pixel.

For example, in a case of N=2, n=1; and in a case that N is greater than 2, n=2.

For example, the method further includes adjusting the driving signal for next one or more refresh frames relative to the driving signal for the last hold frame in a current group of N consecutive frames, in response to receiving an instruction of switching from the second frequency to the first frequency.

For example, the driving signal includes at least one of a light emitting control signal, a first initial voltage, a second initial voltage, a power supply voltage and a reference voltage, and the adjusting the driving signal for next one or more refresh frames relative to the driving signal for the last hold frame in the current group of N consecutive frames includes at least one of: adjusting an effective level duration of the light emitting control signal for the next one or more refresh frames, so that the effective level duration of the light emitting control signal for the next one or more refresh frames is greater than the effective level duration of the light emitting control signal for the last hold frame; adjusting the first initial voltage for the next one or more refresh frames, so that the first initial voltage for the next one or more refresh frames is negatively biased relative to the first initial voltage for the last hold frame; adjusting the second initial voltage for the next one or more refresh frames, so that the second initial voltage for the next one or more refresh frames is positively biased relative to the second initial voltage for the last hold frame; and adjusting at least one of the power supply signal and the reference signal for the next one or more refresh frames, so that an absolute difference between the power supply signal and the reference signal for the next one or more refresh frames is greater than an absolute difference between the power supply signal and the reference signal for the last hold frame.

### BRIEF DESCRIPTION OF THE DRAWINGS

FIG. 1 illustrates a schematic block diagram of a display device according to embodiments of the present disclosure.

FIG. 2 shows an exemplary circuit diagram of a sub-pixel according to embodiments of the present disclosure.

FIG. 3 shows a schematic diagram of a working principle of a display device at different frequencies according to embodiments of the present disclosure.

FIG. 4A shows a timing diagram of signals of the sub-pixel of FIG. 2 in a refresh frame.

FIG. 4B shows a timing diagram of signals of the sub-pixel of FIG. 2 in a hold frame.

FIG. 5 shows a diagram of a brightness change of a display device when switching frequency.

FIG. 6 shows a schematic diagram of adjusting an effective level duration of a light-emitting control signal by a display device according to embodiments of the present disclosure.

FIG. 7 shows an adjustment of an effective level duration of a light-emitting control signal by a display device at different display brightness values according to embodiments of the present disclosure.

FIG. 8 shows a schematic diagram of adjusting an amplitude of a light-emitting control signal by a display device according to embodiments of the present disclosure.

FIG. 9 shows a schematic diagram of adjusting a first initial voltage and a second initial voltage by a display device according to embodiments of the present disclosure.

FIG. 10 shows a flowchart of a method of driving a display device according to embodiments of the present disclosure.

### DETAILED DESCRIPTION OF EMBODIMENTS

Although the present disclosure will be fully described with reference to accompanying drawings containing preferred embodiments in the present disclosure, prior to the description, it should be understood that those of ordinary skill in the art may modify the present disclosure while obtaining technical effects of the present disclosure. Therefore, it should be understood that the above description is a broad disclosure for those of ordinary skill in the art, and its content is not intended to limit exemplary embodiments described in the present disclosure.

In addition, in the detailed description below, for the sake of explanation, many specific details are elaborated to provide a comprehensive understanding of embodiments in the present disclosure. However, it is evident that one or more embodiments may also be implemented without these specific details. In other cases, well-known structures and devices are illustrated to simplify the accompanying drawings.

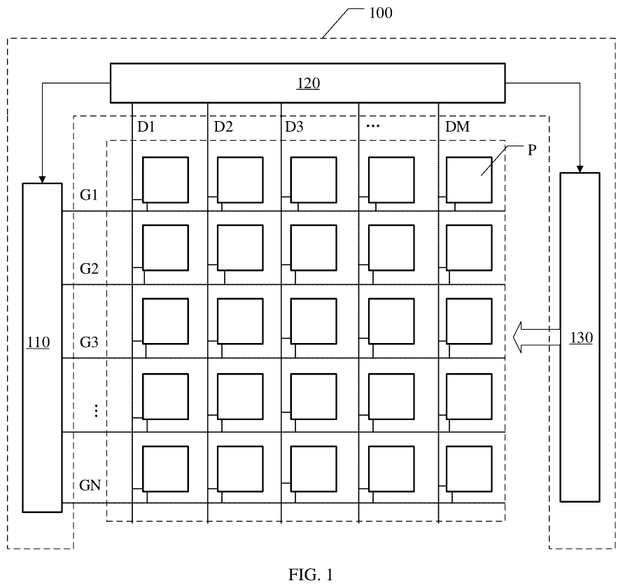

FIG. 1 shows a schematic diagram of a display device according to embodiments of the present disclosure.

As shown in FIG. 1, the display device includes a plurality of sub-pixels P and a driving circuit 100. The plurality of sub-pixels P may be arranged in an array including rows and columns, for example, in an N×M array, where N and M are integers greater than 1. The driving circuit 100 is connected to the plurality of sub-pixels P to apply driving signals and data signals to the plurality of sub-pixels P. For example, driving signals G1 to GN are applied to each row of sub-pixels P, and data signals D1 to DM are applied to each column of sub-pixels P (hereinafter collectively referred to as a data signal Data). Each sub-pixel P may receive a data signal and emit light under control of a received driving signal.

In some embodiments, the driving signal applied by the driving circuit 100 to each sub-pixel P may be a set of signals, including but not limited to a gate driving signal, a light-emitting control signal, an initial voltage, a power supply voltage, a reference voltage, and so on. The gate driving signal is used to control the sub-pixel to turn on, in order to receive the data signal or maintain the received data signal. The light-emitting control signal is used to control the sub-pixel to emit light. The initial voltage may include at least one of a first initial voltage and a second initial voltage. The first initial voltage is used to initialize a voltage of a first electrode of the light-emitting element of the sub-pixel, and the second initial voltage is used to initialize a voltage of an input terminal of the driving transistor for driving the light-emitting element of the sub-pixel. The power supply voltage and the reference voltage are used to supply power to the sub-pixel.

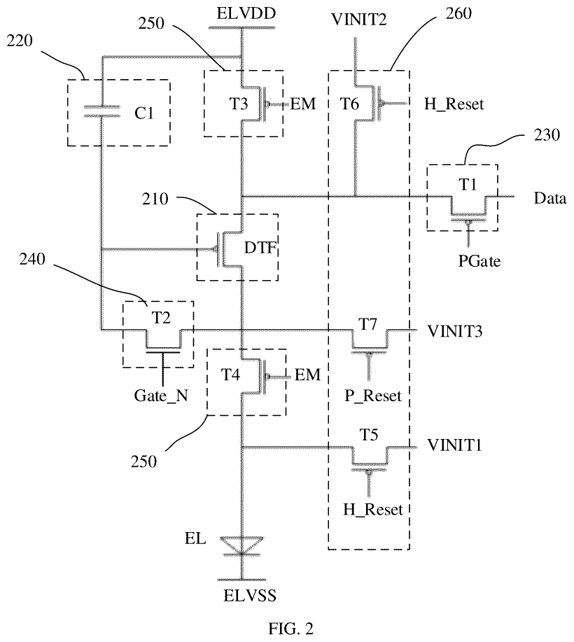

Various driving signals will be described in detail below by taking a circuit structure of a sub-pixel P shown in FIG. 2 as an example.

As shown in FIG. 2, the sub-pixel may include a light-emitting element EL and a pixel driving circuit for driving the light-emitting element EL to emit light. The pixel driving circuit may include a driving sub-circuit 210, a storage sub-circuit 220, an input sub-circuit 230, an input control sub-circuit 240, a light-emitting control sub-circuit 250 and an initialization sub-circuit 260. The pixel driving circuit may generate a driving current based on the data signal (Data) under control of the driving signal, thereby driving the light-emitting element EL to emit light. The driving signal applied to the pixel driving circuit include but are not limited to the gate driving signal (such as a first gate driving signal PGate, a second gate driving signal Gate_N), a light-emitting control signal EM, a first reset signal H_Reset, a second reset signal P_Reset, a first initial voltage VINTI1, a second initial voltage VINIT2, a third initial voltage VINIT3, a power supply voltage ELVDD, a reference voltage ELVSS, and so on. Hereafter, detailed description will be made with reference to FIG. 2.

The driving sub-circuit 210 may include a control terminal, an input terminal, and an output terminal. For example, the driving sub-circuit 210 may include a driving transistor DTF. A gate of the driving transistor DTF may act as the control terminal of the driving sub-circuit 210, a first electrode of the driving transistor DTF may act as the input terminal of the driving sub-circuit 210, and a second electrode of the driving transistor DTF may act as the output terminal of the driving sub-circuit 210.

The storage sub-circuit 220 is connected between the control terminal of the driving sub-circuit and a power supply signal terminal for receiving a power supply voltage. For example, the storage sub-circuit 220 may include a capacitor C1. A first electrode of the capacitor C1 is connected to the control terminal of the driving sub-circuit 210, and a second electrode of the capacitor C2 is connected to the power supply signal terminal for providing the power supply voltage ELVDD (for ease of description below, the power supply signal terminal is also denoted by ELVDD).

The input sub-circuit 230 is connected to the input terminal of the driving sub-circuit 210. The input sub-circuit 230 may provide the data signal Data to the input terminal of the driving sub-circuit under control of the first gate driving signal PGate. For example, the input sub-circuit 230 may include a first transistor T1. A gate of the first transistor T1 is used to receive the first gate driving signal PGate, a first electrode of the first transistor T1 is used to receive the data signal Data, and a second electrode of the first transistor T1 is connected to the input terminal of the driving sub-circuit 210, for example, to the first electrode of the driving transistor DTF.

The input control sub-circuit 240 is connected between the output terminal of the driving sub-circuit and the control terminal of the driving sub-circuit. The output terminal of the driving sub-circuit 210 may be electrically connected to the control terminal of the driving sub-circuit 210 by the input control sub-circuit 240 under control of the second gate driving signal. For example, the input control sub-circuit 240 may include a second transistor T2. A gate of the second transistor T2 is used to receive the second gate driving signal Gate_N. A first electrode of the second transistor T2 is connected to the output terminal of the driving circuit 210, for example, to the second electrode of the driving transistor DTF. A second electrode of the second transistor T2 is connected to the control terminal of the driving sub-circuit 210, for example, to the gate of the driving transistor DTF.

The light-emitting control sub-circuit 250 is connected between the driving sub-circuit 210 and the power signal terminal ELVDD, and between the driving sub-circuit 210 and the light-emitting element. The light-emitting control sub-circuit 250 may turn on a path from the power supply signal terminal ELVDD to the light-emitting element through the driving sub-circuit under control of the light-emitting control signal EM. For example, the light-emitting control sub-circuit 250 may include a third transistor T3 and a fourth transistor T4. A gate of the third transistor T3 is used to receive the light-emitting control signal EM, a first electrode of the third transistor T3 is connected to the power supply signal terminal ELVDD, and a second electrode of the third transistor T3 is connected to the input terminal of the driving sub-circuit 210, for example, to the first electrode of the driving transistor DTF. A gate of the fourth transistor T4 is used to receive the light-emitting control signal EM, a first electrode of the fourth transistor T4 is connected to the output terminal of the driving sub-circuit 210, for example, to the second electrode of the driving transistor DTF, and a second electrode of the fourth transistor T4 is connected to the first electrode of the light-emitting element EL, for example, to the anode of the light-emitting element EL.

The initialization sub-circuit 260 is connected to the input terminal of the driving sub-circuit 210, the output terminal of the driving sub-circuit 210, and the input terminal of the light-emitting element EL. The initialization sub-circuit 260 may initialize a voltage of the input terminal of the driving sub-circuit 210, a voltage of the output terminal of the driving sub-circuit 210, and a voltage of the first electrode of the light-emitting element EL. The second electrode of the light-emitting element EL (such as a cathode) is connected to a reference signal terminal of the ELVSS for receiving the reference voltage (for ease of description in the following text, the reference signal terminal is also denoted by ELVSS). For example, the initialization sub-circuit 260 may include a fifth transistor T5, a sixth transistor T6, and a seventh transistor T7. A gate of the fifth transistor T5 is used to receive the first reset signal H_Reset, a first electrode of the fifth transistor T5 is used to receive the first initial voltage VINIT1, and a second electrode of the fifth transistor T5 is connected to the first electrode of the light-emitting element EL. A gate of the sixth transistor T6 is used to receive the first reset signal H_Reset, a first electrode of the sixth transistor T6 is used to receive the second initial voltage VINIT2, and a second electrode of the sixth transistor T6 is connected to the input terminal of the driving sub-circuit 210, for example, to the first electrode of the driving transistor DTF. A gate of the seventh transistor T7 is used to receive the second reset signal P_Reset, a first electrode of the seventh transistor T7 is used to receive the third initial voltage VINIT3, and a second electrode of the seventh transistor T7 is connected to the output terminal of the driving sub-circuit 210, for example, to the second electrode of the driving transistor DTF.

In the above embodiments, the transistors T1, T3 to T7 may be P-type transistors, and the transistor T2 may be an N-type transistor. However, the embodiments of the present disclosure are not limited to this, and the type of transistor may be selected as desired.

An example of the circuit structure of the sub-pixel in the embodiments of the present disclosure is described above with reference to FIG. 2. However, this is only to explain functions of various driving signals. The embodiments of the present disclosure are not limited to this, and the sub-pixel may adopt any suitable circuit structure as desired.

Returning to FIG. 1, in some embodiments, the driving circuit 100 may include a gate driving circuit 110 and a driving control circuit 120. The gate driving circuit 110 is connected to the plurality of sub-pixels P. The gate driving circuit 110 may generate a gate driving signals and a light-emitting control signal, such as the first gate driving signal PGate, the second gate driving signal Gate_N, and the light-emitting control signal EM as described above. The plurality of sub-pixels P may be provided in the display region of the display panel, and the gate driving circuit 110 may be a gate driver on array (GOA) provided in a peripheral region of the display panel, which is used to achieve the driving function through scanning row by row. The driving control circuit 120 is connected to the gate driving circuit 110 and the plurality of sub-pixels P. For example, the driving control circuit 120 may be a driving control IC (driver IC), which is electrically connected to the gate driving circuit 110 and the plurality of sub-pixels P on the display panel through engagement. The driving control circuit 120 may control the gate driving circuit 110 to generate gate driving signals (such as the first gate driving signal PGate and the second gate driving signal Gate_N) and the light-emitting control signal (such as the light-emitting control signal EM), and may apply the data signal Data to the plurality of sub-pixels P. In some embodiments, the driving control circuit 120 may also provide an initial voltage to the plurality of sub-pixels P, such as but not limited to any one or more of the first initial voltage VINIT1, the second initial voltage VINIT2, and the third initial voltage VINIT3 as described above.

In some embodiments, the driving circuit 100 may also include a power supply circuit 130 for providing the power supply voltage ELVDD and the reference voltage ELVSS to the sub-pixel P. The power supply circuit 130 may be implemented by a Power IC, for example, by the Power IC in a main control unit of an electronic device. The driving control circuit 120 may control the power supply circuit 130 to adjust at least one of the power supply voltage ELVDD and the reference voltage ELVSS provided to the sub-pixel P.

According to the embodiments of the present disclosure, the display device may have a multi-frequency display function. For example, the display device may be displayed at a first frequency or at a second frequency, which may be different from the first frequency. For example, the first frequency may be an integer multiple of the second frequency. The so-called frequency here refers to a refresh rate of the display device. The display device may achieve multi-frequency display by inserting hold frames between refresh frames. For example, in a case of displaying at a first frequency, the driving circuit 100 may take each frame as a refresh frame, generate a driving signal for the refresh frame, and apply the generated driving signal for the refresh frame and a data signal to the plurality of sub-pixels of the display device, so that the plurality of sub-pixels receive the data signal and emit light, under control of the driving signal for the refresh frame. In a case of displaying at a second frequency, the driving circuit 100 may take N consecutive frames comprising a refresh frame and N−1 hold frames as a group, generate, for each group, a driving signal for the refresh frame in the group and a driving signal for each of the N−1 hold frames in the group, and apply the generated driving signal for the refresh frame and the generated driving signal for each of the hold frames to the plurality of sub-pixels, so that the plurality of sub-pixels receive the data signal and emit light under control of the driving signal for the refresh frame, and maintain the received data signal and emit light under control of the driving signal for each of the hold frames, wherein N is a ratio of the first frequency to the second frequency, and N is an integer greater than 1.

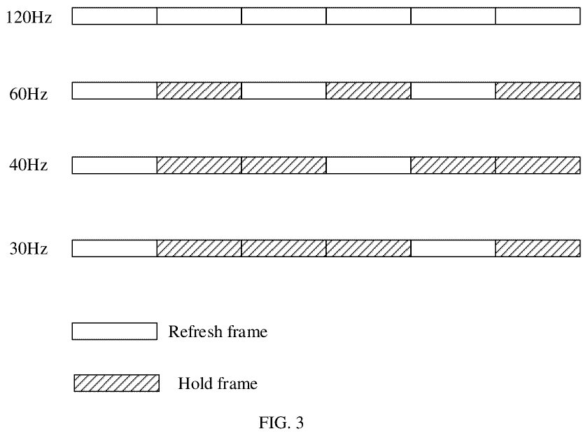

FIG. 3 shows a schematic diagram of a working principle of a display device at different frequencies according to embodiments of the present disclosure.

As shown in FIG. 3, assuming that the highest refresh rate (i.e. base frequency) of the display device is 120 Hz, when the display device operates at a frequency of 120 Hz, each frame is a refresh frame, and the driving circuit of the display device generates a driving signal for each refresh frame. When the display device operates at a frequency of 60 Hz, the driving circuit may take one refresh frame and one hold frame as a group, and periodically generates a set of driving signals for the refresh frame and a set of driving signals for the hold frame. In the refresh frame, the sub-pixel receives the data signal under control of the driving signal of the refresh frame and displays based on the received data signal. That is to say, the driving circuit controls the sub-pixel to “refresh” the display data. In the hold frame, the sub-pixel maintains the received data signal under control of the driving signal of the hold frame and displays based on the held data signal. That is to say, the driving circuit controls the sub-pixel to “hold” the display data. In this way, at 120 Hz, each frame is a refresh frame, which means that each frame is refreshed, so that the highest refresh frequency is achieved. At 60 Hz, each refresh frame is followed by a hold frame, so that one of every two frames is refreshed, achieving half of the highest frequency, i.e. a refresh frequency of the 60Hz. Similarly, at 40 Hz, each refresh frame is followed by two hold frames, thereby reducing the refresh frequency to one-third of the highest frequency of 120 Hz. At 30 Hz, each refresh frame is followed by three hold frames, reducing the refresh frequency to a quarter of the highest frequency of 120 Hz.

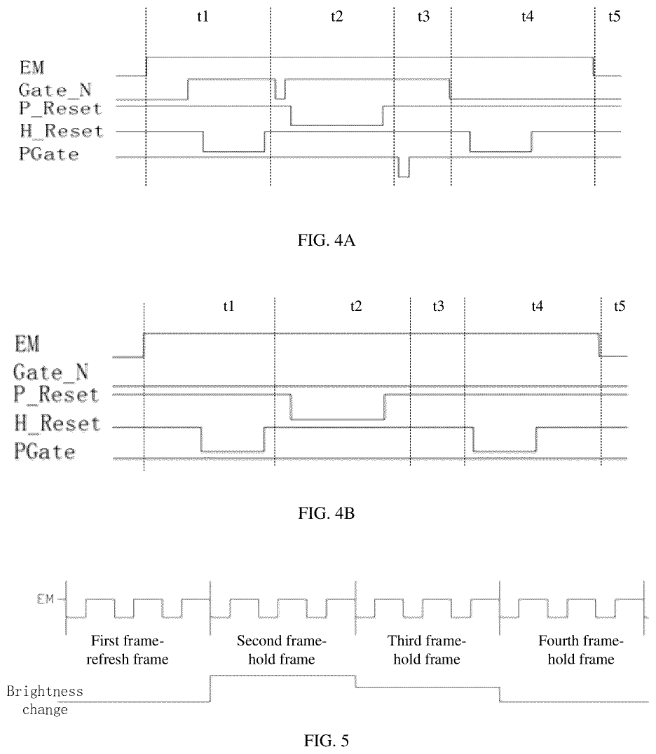

FIG. 4A and FIG. 4B respectively show driving signals for the sub-pixel in FIG. 2 at the refresh and hold frames.

As shown in FIG. 4A, in the refresh frame, in period t1, the second gate driving signal Gate_N is at high level, and the first reset signal H_Reset is at low level. Combined with FIG. 2, the second transistor T2, the fifth transistor T5, and the sixth transistor T6 are turned on, thereby providing the first initial voltage VINIT1 to the first electrode of the light-emitting element EL and providing the second initial voltage VINIT2 to the first electrode of the driving transistor DTF.

In period t2, the first reset signal H_Reset is at high level, the second reset signal P_Reset is at low level, the second gate driving signal Gate_N is at high level, the fifth transistor T5 and the sixth transistor T6 are turned off, the second transistor T2 and the seventh transistor T7 are turned on, thereby writing the third initial voltage VINIT3 to the gate of the driving transistor DTF, and turning on the driving transistor DTF by the third initial voltage VINIT3.

In period t3, the second reset signal P_Reset is at high level, the first gate driving signal PGate is at low level, the second gate driving signal Gate_N remains at high level, the seventh transistor T7 is turned off, the first transistor T1 is turned on, and the second transistor T2 remains on. The data signal Data is written to the gate of the driving transistor DTF through the turned on driving transistor DTF and the turned on second transistor T2.

In period t4, the first gate driving signal PGate is at high level, the second gate driving signal Gate_N is at low level, and both the second transistor T2 and the first transistor T1 are turn off. The first reset signal H_Reset is at low level, and the fifth transistor T5 and sixth transistor T5 are turned on. The first initial voltage VINIT1 is provided to the first electrode of the light-emitting element EL again, and the second initial voltage VINIT2 is provided to the first electrode of the driving transistor DTF.

During period t5, the first reset signal H_Reset is at high level, the fifth transistor T5 and sixth transistor T6 are turned off, the light-emitting control signal EM is at low level, and the third transistor T3 and the fourth transistor T4 are turned on, thereby turning on a path from the power supply signal terminal ELVDD to the light-emitting element EL through the driving transistor DTF. The driving transistor DTF generates a driving current based on the data signal written into the gate of the driving transistor DTF. The generated driving current is provided to the first electrode of the light-emitting element EL through the turned-on fourth transistor T4, thereby driving the light-emitting element EL to emit light. At this point, the display driving for the refresh frame has been completed.

As shown in FIG. 4B, in the hold frame, the signal waveforms of the light-emitting control signal EM, the first reset signal H-Reset, and the second reset signal P_Reset are the same as those of the refresh frame. Unlike the refresh frame, the first gate driving signal PGate remains at high level and the second gate driving signal Gate_N remains at low level. That is to say, in the hold frame, the first transistor T1 and the second transistor T2 remain off, so that the data signal written to the gate of the driving transistor DTF will be held at the gate of the driving transistor DTF due to the presence of the capacitor C1. Whenever the low level of the light-emitting control signal EM arrives, the driving transistor DTF generates a driving current based on the data signal held at the gate of the driving transistor DTF to drive the light-emitting element EL to emit light. In this way, the display driving for the hold frames has been achieved.

When switching from high frequency to low frequency, the refresh frame suddenly changes to the hold frame. Since the first transistor T1 and the second transistor T2 in the hold frame remain off, the data is not written. At the moment of switching, the timing of the signals suddenly changes, and the loading drop and delay of the display device will cause a transient brightness change during switching, so that the brightness of the hold frame is higher than the brightness of the refresh frame. Conversely, when switching from low frequency to high frequency, the hold frame suddenly becomes a refresh frame, so that the brightness of the refresh frame is lower than the brightness of the previous hold frame.

As shown in FIG. 5, taking switching from 120 Hz to 30 Hz as an example, in a working mode at 120 Hz, display driving is performed by taking each frame as a refresh frame. In a working mode at 30 H, for every four consecutive frames, the first frame is taken as a refresh frame, and the third to fourth frames are taken as hold frames. That is, display driving is performed by taking one refresh frame and three hold frames as a group. When switching from 120 Hz to 30 Hz, due to the impact of loading drop and delay of the screen, the refresh frame suddenly becomes a hold frame. The brightness of each of the second and third frames (i.e. the first two hold frames) will be higher than the brightness of the first frame (i.e. the refresh frame), and the brightness difference with the first frame is different between the second frame and the third frame (the brightness difference between the second and first frames is greater than the brightness difference between the third and first frames). From the fourth frame, the brightness becomes stable.

According to embodiments of the present disclosure, the driving circuit in the display device may adjust the driving signal for each of 1^{st} to n^{th} hold frames in a next group of N consecutive frames relative to the driving signal for the refresh frame in the next group of N consecutive frames, in response to receiving an instruction of switching from the first frequency to the second frequency, where N is a ratio of the first frequency to the second frequency, 1≤n≤N−1. It is also possible for the driving circuit in the display device to adjust the driving signal of next one or more refresh frames relative to the driving signal for the last hold frame among the N consecutive frames in the current group, in response to receiving an instruction of switching from the second frequency to the first frequency. In this way, it is possible to compensate for the brightness change at the moment of frequency switching as described above.

In some embodiments, the driving circuit may adjust the driving signal by a factor based on a current display brightness value (DBV) of the display device. For example, when switching from the first frequency to the second frequency, the driving signal of the 1^{st} to n^{th} hold frames after the next refresh frame is adjusted; and when switching from the second frequency to the first frequency, the driving signal of the next refresh frame is adjusted. The larger the display brightness value, the greater the factor. In some embodiments, the driving circuit may adjust the driving signal for each of the 1^{st} to n^{th} hold frames such that the factor by which the driving signal for an n1^{th} hold frame is adjusted is greater than the factor by which the driving signal for an n2^{th} hold frame is adjusted, where 1≤n1≤n2≤n. In some embodiments, when N=2, n=1. In some embodiments, when N is greater than 2, n=2.

The driving signals adjusted during frequency switching include but are not limited to at least one of the light-emitting control signal, the first initial voltage, the second initial voltage, the power supply voltage, and the reference voltage. The light-emitting control signal is used to control the sub-pixel to emit light, such as but not limited to the light-emitting control signal EM as described above. The first initial voltage is the anode voltage used to initialize the light-emitting element of the sub-pixel, such as but not limited to the first initial voltage VINIT1 as described above. The second initial voltage is used to initialize the input terminal voltage for a driving transistor of the sub-pixel for driving the light-emitting element, such as but not limited to the second initial voltage VINIT2 as described above. The power supply voltage and the reference voltage are used to supply power to the sub-pixel, such as but not limited to the power supply voltage ELVDD and the reference voltage ELVSS mentioned above.

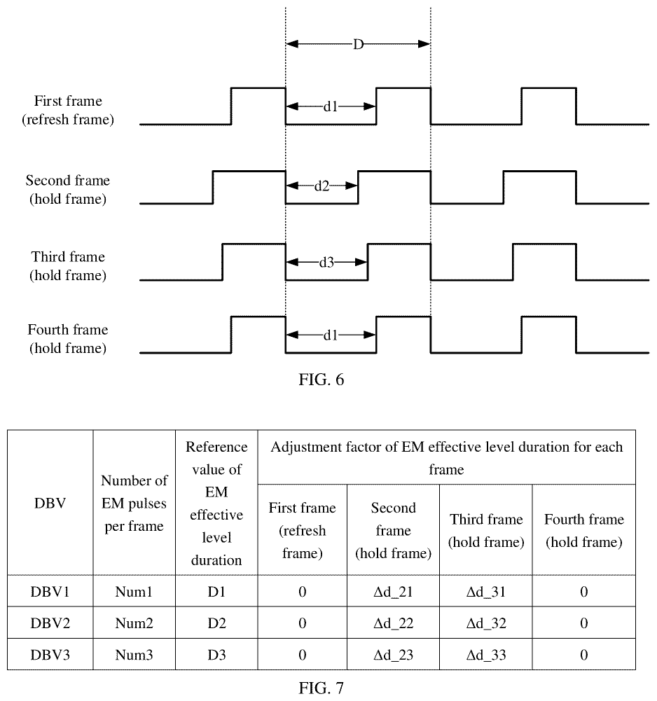

The compensation methods for various driving signals will be described in detail below with reference to FIG. 6 to FIG. 9.

Taking an adjustment object being a light-emitting control signal as an example, upon receiving an instruction of switching from the first frequency to the second frequency, the driving circuit may adjust a waveform parameter of the light-emitting control signal for each of the 1^{st} to n^{th} hold frames in the next group of N consecutive frames relative to a waveform parameter of the light-emitting control signal for the refresh frame in the next group of N consecutive frames, so that the waveform parameter of the light-emitting control signal for the each of the 1^{st} to n^{th} hold frames is adjusted to be smaller than the waveform parameter of the light-emitting control signal for the refresh frame. The waveform parameter adjusted here includes at least one of an effective level duration and an amplitude.

FIG. 6 shows a schematic diagram of adjusting an effective level duration of a light-emitting control signal by a display device according to embodiments of the present disclosure. As shown in FIG. 6, when switching from 120 Hz to 30 Hz, the driving mode will switch from taking each frame as a refresh frame to taking one refresh frame and three hold frames as a group. The driving circuit may adjust the effective level duration of the light-emitting control signal in the second frame (first hold frame) and the third frame (second hold frame) relative to the first frame (refresh frame) for the next group of four consecutive frames. For example, assuming the effective level duration of the light-emitting control signal for the first frame being d1, the effective level duration of the light-emitting control signal for the second frame is set to d2 and the effective level duration of the light-emitting control signal for the third frame is set to d3, where d2 and d3 are both less than d1.

Since the effective light-emitting duration of the sub-pixel is controlled by the light-emitting control signal EM, the measured brightness is actually equivalent to the integration of the light-emitting control signal EM at the effective level duration (in this embodiment, duration of low level) over the entire cycle. Assuming that the effective level duration of the light-emitting control signal is 60% of the entire signal cycle, the sub-pixel would have an effective light-emitting duration being 60% of the entire signal cycle and a non-light-emitting time being 40% of the entire signal cycle under control of the light-emitting control signal. Accordingly, if the brightness within the effective light-emitting time is 150 nits, the actual measured brightness (average brightness) is 150 nits*60%=90 nits. The frequency of the light-emitting control signal EM is high. For example, the light-emitting control signal EM may have 3 pulses within 1 frame. In this case, frequency of the light-emitting control signal EM would be 360 Hz if the basic frequency is 120 Hz. However, under normal conditions of human eyes, the speed at which human eyes recognize coherent images is 24 frames per second, and generally the maximum frequency at which a single color block flickers is 60 Hz. The frequency of the light-emitting control signal EM far exceeds the range that human eyes may recognize. Therefore, human eyes may only perceive the average brightness. In the embodiments of the present disclosure, by adjusting the effective level duration of the light-emitting control signal EM, adjustment of the brightness of the display device may be achieved, thereby compensating for the brightness change at the frequency switching time.

In some embodiments, as shown in FIG. 6, the effective level duration of the light-emitting control signal for each of the second frame and the third frame may be reduced relative to d1, where (d1−2) is greater than (d1−d3), which means that the factor by which the light-emitting control signal for the second frame is adjusted is greater than the factor by which the light-emitting control signal for the third frame is adjusted. The effective level duration of the light-emitting control signal for the fourth frame may remain unchanged, that is, it remains d1. For example, in the case shown in FIG. 5, the brightness difference between the second frame (i.e. the 1^{st} hold frames) and the first frame is unequal to, e.g. greater than, the brightness difference between the third frame (i.e. the 2^{nd} hold frames) and the first frame. For example, the brightness difference between the second frame (i.e. the 1^{st} hold frames) and the first frame is greater than, the brightness difference between the third frame (i.e. the 2^{nd} hold frames) and the first frame. Therefore, the compensation amount for the second frame (first hold frame) may be greater than that for the third frame (second hold frame). By adjusting more for the second frame than the third frame, the accuracy of compensation may be further improved.

FIG. 7 shows an adjustment of an effective level duration of a light-emitting control signal by a display device at different display brightness values according to embodiments of the present disclosure.

As shown in FIG. 7, the effective level duration of the light-emitting control signal may be adjusted by a factor based on the current display brightness value (DBV) of the display device. The larger the display brightness value, the greater the factor. For example, it is assumed that the display brightness value DBV1 is within a range of 200 nits to 900 nits, the display brightness value DBV2 is within a range of 10 nits to 200 nits, and the display brightness value DBV3 is less than 10 nits. The reference value for the effective level duration of EM may be characterized by a number of rows of sub-pixels scanned per unit pulse duration. For example, it is assumed that the total number of rows of sub-pixels scanned in one frame image is 3168 rows and the number Num1 of pulses (low level pulses) of the light-emitting control signal in one frame is 3 under the display brightness value DBV1, then the number of rows corresponding to each pulse is 3168/3=1056 rows. The 1056 rows per pulse may be taken as a reference value D1 for the effective level duration of the light-emitting control signal under the display brightness value DBV1. Similarly, if the number of pulses Num3 of the light-emitting control signal in one frame is 18 under the display brightness value DBV3, the number of rows corresponding to each pulse is 3168/18=176 rows. The 176 rows per pulse may be taken as a reference value D3 for the effective level duration of the light-emitting control signal under the display brightness value DBV3.

As shown in FIG. 7, when switching from the first frequency to the second frequency, taking switching from 120 Hz to 30 Hz as an example, the first frame in the next four consecutive frames is a refresh frame, and the second to fourth frames in the next four consecutive frames are all hold frames.

Under the display brightness value DBV1, the effective level duration of the first frame (refresh frame) and the effective level duration of the fourth frame (the third hold frame) may be equal to the reference value D1, that is, the adjustment factor for the first and fourth frames is 0. The effective level duration of the light-emitting control signal for the second frame may be adjusted, for example, by a factor of Δd_21, and the effective level duration of the light-emitting control signal for the third frame may be adjusted, for example, by a factor of Δd_31. That is to say, the effective level duration of the light-emitting control signal for the second frame (the first hold frame) is D1+Δd_21, and the effective level duration of the light-emitting control signal for the third frame (the second hold frame) is D1+Δd_31. Here, Δd_21 and Δd_31 may both be negative values, so that the effective level duration of the light-emitting control signal for each of the first hold frame and the second hold frame is less than the reference value D1, i.e. the effective level duration of the light-emitting control signal for the refresh frame. In some embodiments, an absolute value of each of Δd_21 and Δd_31 may be in a range of 8 to 12. In some embodiments, the absolute value of Δd_21 is greater than the absolute value of Δd_31. In other words, the adjustment factor for the first hold frame is greater than the adjustment factor for the second hold frame, thereby achieving targeted compensation for the stepped brightness change as shown in FIG. 5. For example, the absolute value of Δd_21 may be 8 to 12 rows of sub-pixels/pulses, and the absolute value of Δd_31 may be 4 to 8 rows of sub-pixels/pulses.

For example, it is assumed that DBV1 is 500 nits under w255, the effective level duration (duration of low level) of the light-emitting control signal for the second frame is reduced from the reference value of 1056 rows per pulse to 1044 rows per pulse (i.e. Δd_21=−12), and the effective level duration of the light-emitting control signal for the third frame is adjusted from the reference value of 1056 rows per pulse to 1052 rows per pulse (Δd_21=−4). Since the brightness of the second frame (the first hold frame) changes greatly, the adjustment factor (i.e. the compensation factor) is large. Since the brightness of the third frame (the second hold frame) returns greatly in positive direction, the adjustment factor (i.e. the compensation factor) for the third frame is relatively small.

Similarly, under the display brightness value DBV2, when switching from the first frequency to the second frequency, the effective level duration of each of the first frame (refresh frame) and the fourth frame (third hold frame) is equal to the reference value D2, that is, the adjustment factor for the first and fourth frames is 0. The effective level duration of the light-emitting control signals for the second frame (first hold frame) is adjusted by a factor of Δd_22 and the effective level duration of the light-emitting control signals for the third frame (second hold frame) is adjusted by a factor of Δd_32, where Δd_22 and Δd_32 are also negative values. For example, an absolute value of each of Δd_22 and Δd_32 is in a range of 0 to 8. The absolute value of Δd_22 may also be greater than the absolute value of Δd_32. For example, the absolute value of Δd_22 may be in a range of 4 to 8, and the absolute value of Δd_32 may be in a range of 0 to 4.

Under the display brightness value DBV3, when switching from the first frequency to the second frequency, the effective level duration of each of the first frame (refresh frame) and the fourth frame (third hold frame) is equal to the reference value D3, that is, the adjustment factor for the first and fourth frames is 0. The effective level duration of the light-emitting control signal for the second frame (first hold frame) is adjusted by a factor of Δd_23 and the effective level duration of the light-emitting control signal for the third frame (second hold frame) is adjusted by a factor of Δd_33, where Δd_23 and Δd_33 are also negative values, and the absolute value of Δd_23 may also be greater than the absolute value of Δd_33. In some embodiments, an absolute value of each of Δd_23 and Δd_33 may be in a range of 0 to 4. In some embodiments, an absolute value of Δd_23 may be in a range of 0 to 4, and Δd_33 may be 0.

Comparing in a vertical perspective, the same frame has different adjustment factors under different display brightness values. For example, DBV1>DBV2>DBV3. In this case, for the second frame (the first hold frame), the absolute value of Δd_21 is greater than the absolute value of Δd_22, and the absolute value of Δd_22 is greater than the absolute value of Δd_23. For the third frame (the second hold frame), the absolute value of Δd_31 is greater than the absolute value of Δd_32, and the absolute value of Δd_32 is greater than the absolute value of Δd_33.

The brightness of W255 varies with the DBV of the display device. The DBV value of the display device may be set in various ways. Taking a mobile phone as an example, users may adjust the DBV of the phone by sliding the brightness bar on the phone. When switching between frequencies, the brightness is changed by different amounts under different DBVs. In the embodiments of the present disclosure, by adjusting the driving signal according to the DBV, the compensation accuracy may be further improved.

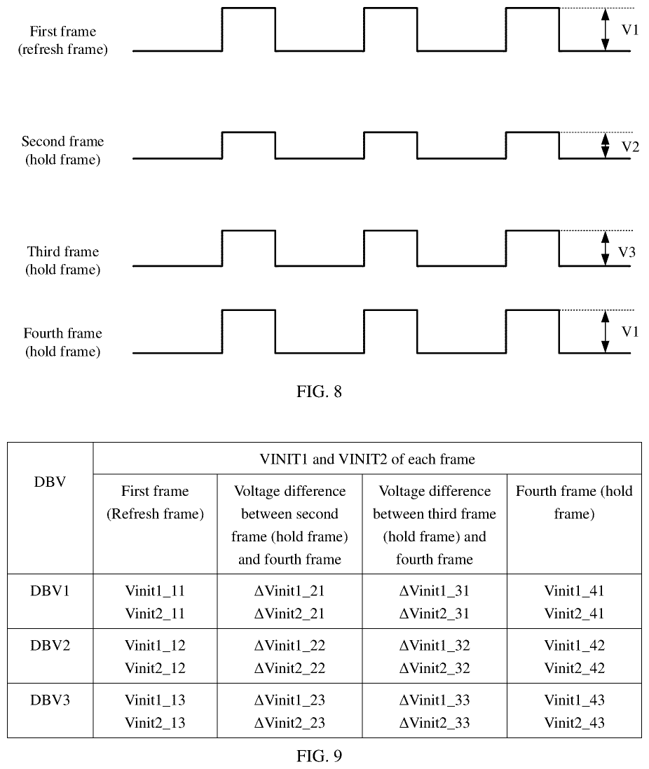

FIG. 8 shows a schematic diagram of adjusting an amplitude of a light-emitting control signal by a display device according to embodiments of the present disclosure.

As shown in FIG. 8, taking switching from 120 Hz to 30 Hz as an example, the driving mode will switch from taking each frame as a refresh frame to taking 1 refresh frame and 3 hold frames as a group. The driving circuit may adjust an amplitude of the light-emitting control signal for each of the second frame (the first hold frame) and the third frame (the second hold frame) relative to the first frame (the refresh frame) in the next group of four consecutive frames. For example, if the amplitude of the light-emitting control signal for the first frame is V1, the amplitude of the light-emitting control signal for each of the second frame and the third frame may be adjusted relative to V1. For example, the amplitude of the second frame is adjusted to V2, and the amplitude of the third frame is adjusted to V3, where V2 and V3 are both smaller than V1. In some embodiments, as shown in FIG. 8, the amplitude of the light-emitting control signal for each of the second frame and the third frame may be reduced relative to V1, where (V1−V2) is greater than (V1−V3), which means that a factor by which the amplitude of the second frame is adjusted is greater than a factor by which the amplitude of the third frame is adjusted. The amplitude of the light-emitting control signal for the fourth frame may remain unchanged, that is, it remains V1.

By slightly adjusting the amplitude of the light-emitting control signal, taking the sub-pixel structure in FIG. 2 as an example, a degree of turning on the third transistor T3 and the fourth transistor T4 may be adjusted, thereby playing a role in adjusting brightness. In some embodiments, amplitude adjustment may be achieved by adjusting the amplitude of the light-emitting control signal at low level. As shown in FIG. 8, the light-emitting control signals are different in amplitude, so that the charging waveforms are different. The greater the amplitude of the light-emitting control signal at low level, the greater the degree to which the third transistor T3 and the fourth transistor T4 are turned on, the greater the brightness. By adjusting the amplitude of the light-emitting control signal for different frames, such as adjusting the reference voltage (VGL voltage) of the gate driving circuit (GOA) corresponding to the light-emitting control signal, different brightness levels may be obtained. The driving control circuit may provide two or more reference voltages (such as VGL1, VGL2, . . .), and one of the reference voltages may be configured for the light-emitting control signal without affecting voltages of other signals in the gate driving circuit.

In some embodiments, the adjustment of the effective level duration of the light-emitting control signal and the adjustment of the amplitude of the light-emitting control signal may be combined. For example, if the adjustment of the effective level duration of the light-emitting control signal for the third frame (the second hold frame) under the DBV of 500 nits as described above fails to meet the requirements, such as reducing the brightness by 12 rows is too low while reducing the brightness by 8 rows is still slightly high, the amplitude of the light-emitting control signal may also be adjusted to achieve more precise adjustment.

According to the embodiments of the present disclosure, brightness compensation may be achieved by adjusting at least one of the first initial voltage and the second initial voltage when switching frequency. For example, when switching from the first frequency to the second frequency, for a next group of N consecutive frames (1 refresh frame and N−1 hold frames), a first initial voltage for an (N−1)^{th} hold frame among the N−1 hold frames may be adjusted so that the first initial voltage for the (N−1)^{th} hold frame is positively biased relative to the first initial voltage for the refresh frame. Then, a first initial voltage for each of 1^{st} to n^{th} hold frames among the N−1 hold frames is adjusted so that the first initial voltage for each of the 1^{st} to n^{th} hold frames is positively biased relative to the first initial voltage for the (N−1)^{th} hold frame. For another example, when switching from the first frequency to the second frequency, the second initial voltage for the (N−1)^{th} hold frame among the N−1 hold frames may be adjusted so that the second initial voltage for the (N−1)^{th} hold frame is positively biased relative to the second initial voltage for the refresh frame. Then, the second initial voltage for each of the 1^{st} to n^{th} hold frames among the N−1 hold frames is adjusted so that the second initial voltage for each of the 1^{st} to n^{th} hold frames is negatively biased relative to the second initial voltage for the (N−1)^{th} hold frame.

FIG. 9 shows a schematic diagram of adjusting a first initial voltage and a second initial voltage by a display device according to embodiments of the present disclosure.

As shown in FIG. 9, when switching from high frequency to low frequency, taking switching from 120 Hz to 30 Hz as an example, the first frame in the next four consecutive frames is a refresh frame, and the second to fourth frames in the next four consecutive frames are hold frames. The display brightness values DBV1 to DBV3 may be set as those in the embodiments described above, which will not be repeated here.

Compensation for brightness changes may be achieved by adjusting the first initial voltage.

As shown in FIG. 9, under the display brightness value DBV1, the first initial voltage for the first frame (refresh frame) is Vinit1_11. By adding a positive bias to Vinit1_11, the first initial voltage Vinit1_41 for the fourth frame (i.e., the last hold frame) may be obtained. For example, assuming Vinit1_11 is −3.2V, Vinit1_41 may be adjusted to −3.17V, i.e. positively biased by 0.03V relative to −3.2V. Then, adjustment is made based on the first initial voltage Vinit1_41 for the fourth frame (i.e., the last hold frame), so as to obtain the first initial voltages for the second frame (first hold frame) and the third frame (second hold frame). For example, the first initial voltage for the second frame (first hold frame) may be determined as Vinit1_41+ΔVinit1_21, and the first initial voltage for the third frame (second hold frame) may be determined as Vinit1_41+ΔVinit1_31. If Vinit1_41 is a negative voltage, ΔVinit1_21 and ΔVinit1_31 may both be negative values, so as to achieve positive bias. The absolute values of ΔVinit1_21 and ΔVinit1_31 may represent the factors by which the first initial voltages for the second and third frames are adjusted. In some embodiments, the absolute values of ΔVinit1_21 and ΔVinit1_31 may be in a range of 0.02V to 0.05V. In some embodiments, the absolute value of ΔVinit1_21 may be greater than the absolute value of ΔVinit1_31, that is, the factor by which the first initial voltage for the second frame is adjusted is greater than the factor by which the first initial voltage for the third frame is adjusted. For example, the absolute value of ΔVinit1_21 is in a range of 0.04V to 0.05V, and the absolute value of ΔVinit1_31 may be in a range of 0.01V to 0.03V.

Similarly, under the display brightness value DBV2, the first initial voltage Vinit1_12 for the first frame may be positively biased to obtain the first initial voltage Vinit_42 for the fourth frame. Then, the first initial voltage for the second frame is determined as Vinit_42+ΔVinit1_32, and the first initial voltage for the third frame is determined as Vinit_42+ΔVinit1_32. The absolute values of ΔVinit1_22 and ΔVinit1_32 may be within a range of 0.01V to 0.04V. The absolute value of ΔVinit1_22 may be greater than the absolute value of ΔVinit1_32. For example, the absolute value of ΔVinit1_22 is in a range of 0.02V to 0.04V, and the absolute value of ΔVinit1_32 is in a range of 0.01V to 0.02V.

Similarly, under the display brightness value DBV3, the first initial voltage Vinit_43 for the fourth frame may be obtained based on the first initial voltage Vinit1_13 for the first frame. Then, Vinit_43 may be added to ΔVinit1_23 and ΔVinit1_33 respectively to obtain the first initial voltage for the second frame and the first initial voltage for the third frame. The absolute values of ΔVinit1_23 and ΔVinit1_33 may be within a range of 0V to 0.02V. For example, the absolute value of ΔVinit1_23 may be in a range of 0.01V to 0.02V, for example, it may be 0.02V. The absolute value of ΔVinit1_33 may be within a range of OV to 0.01V.

Comparing in vertical perspective, the same frame may have different adjustment factors under different display brightness values. The larger the display brightness value, the greater the adjustment factor. Taking the second frame (the first hold frame) as an example, DBV1>DBV2>DBV3, the absolute value of ΔVinit1_21 is greater than the absolute value of ΔVinit1_22, and the absolute value of ΔVinit1_22 is greater than the absolute value of ΔVinit1_23. Similarly, for the third frame (the second hold frame), the absolute value of ΔVinit1_31 is greater than the absolute value of ΔVinit1_32, and the absolute value of ΔVinit1_32 is greater than the absolute value of ΔVinit1_33.

In some embodiments, compensation for brightness changes may also be achieved by adjusting the second initial voltage. The second initial voltage may be adjusted in a similar manner as the first initial voltage.

As shown in FIG. 9, under the displayed brightness value DBV1, the second initial voltage for the first frame (refresh frame) is Vinit2_11. By adding a negative bias to Vinit2_11, the second initial voltage Vinit2_41 for the fourth frame (i.e., the last hold frame) may be obtained. For example, assuming Vinit2_11 is 6.5V, Vinit2_41 may be adjusted to 6.53V, i.e. positively biased by 0.03V relative to 6.5V. Then, the second initial voltage for the second frame (first hold frame) is determined as Vinit2_41+ΔVinit2_21, and the second initial voltage for the third frame (second hold frame) is determined as Vinit2_41+ΔVinit2_31. If Vinit2_41 is a positive voltage, ΔVinit2_21 and ΔVinit2_31 may both be negative values, so as to achieve negative bias. The absolute values of ΔVinit2_21 and A Vinit2_31 may represent the adjustment factors of the second initial voltages for the second and third frames. In some embodiments, the absolute values of ΔVinit2_21 and ΔVinit2_31 may be in a range of 0.01V to 0.04V. In some embodiments, the absolute value of ΔVinit2_21 may be greater than the absolute value of ΔVinit2_31, that is, the factor by which the second initial voltage for the second frame is adjusted is greater than the factor by which the second initial voltage for the third frame is adjusted. For example, the absolute value of ΔVinit2_21 may be in a range of 0.03V to 0.04V, and the absolute value of A Vinit2_31 may be in a range of 0.01V to 0.02V.

Similarly, under the display of brightness values DBV2 and DBV3, the second initial voltage for each frame may be obtained. The absolute values of ΔVinit2_22 and ΔVinit2_32 under the display brightness value DBV2 may be within a range of 0.01V to 0.03V. The absolute value of ΔVinit2_22 may be greater than the absolute value of ΔVinit2_32. For example, the absolute value of ΔVinit2_22 may be in a range of 0.02V to 0.03V, and the absolute value of ΔVinit2_32 may be in a range of OV to 0.02V, e.g. may be 0.01V. The absolute values of ΔVinit2_23 and A Vinit2_33 under the display brightness value DBV3 may be within a range of 0V to 0.02V. For example, the absolute value of ΔVinit2_23 may be within a range of 0.01V to 0.02V, for example, it may be 0.02V. The absolute value of ΔVinit2_33 may be within a range of 0V to 0.01V.

In some embodiments, under the same voltage difference, vinit3 has higher sensitivity. In view of this, vinit3 voltage may adjusted first, and then fine adjustment may be performed by using vinit2. Vinit2 and vinit3 may be set specifically under different DBVs (taking 120 Hz switching to 30 H as an example).

Taking the circuit structure of the sub-pixel as shown in FIG. 2 as an example, the first initial voltage VINIT1 is the reset reference voltage for the first electrode (anode) of the light-emitting element EL, and the second initial voltage VINIT2 is the bias positive voltage. The lower the amplitude of the first initial voltage VINIT1 (the first initial voltage VINIT1 is negative voltage, and the amplitude refers to the absolute value of the voltage), the higher the screen brightness. The higher the amplitude of the first initial voltage VINIT1, the lower the brightness. The higher the amplitude of the second initial voltage VINIT2 (positive voltage), the higher the brightness. The lower the amplitude of the second initial voltage VINIT2, the lower the brightness. By providing different first initial voltage VINIT1 and/or second initial voltage VINIT2 to different frames, the brightness of each frame may be more precisely and slightly adjusted to achieve a smooth transition when switching between frequencies. In some embodiments, fine adjustment of the voltage is sufficient. For example, the driving control circuit may support a voltage accuracy of 10 mV for the first initial voltage VINIT1 and the second initial voltage VINIT2, which may ensure that the compensation voltage for the first hold frame does not exceed 0.1V (100 mV), and the compensation for the second hold frame does not exceed 0.05V (50 mV). Under the same voltage difference, the sensitivity of the second initial voltage VINIT2 is higher than that of the first initial voltage VINIT1. The second initial voltage VINIT2 may be adjusted first for coarse adjustment, and then fine adjustment may be performed by adjusting the first initial voltage VINIT1.

Again, taking switching from 120 Hz to 30 Hz as an example, the voltage difference between the fourth frame and the first frame is caused by the difference between the refresh frame and the hold frame in steady state. This is the steady-state difference in variable refresh rate (VRR), which is caused by the difference in timing between the driving signals for the refresh and hold frames shown in FIGS. 4A and 4B. In the embodiments of the present disclosure, the adjustment factor for compensating for the transient flicker is determined by taking the fourth frame (the last hold frame) in steady-state as a reference for comparison. In this way, such difference may be compensated for, further improving the stability of display brightness.

In some embodiments, the adjustment of the first initial voltage and the adjustment of the second initial voltage may be combined. For example, a balance adjustment may be performed between the first initial voltage and the second initial voltage based on the brightness compensation effect, thereby achieving the desired compensation effect. Compared to adjusting the first initial voltage or the second initial voltage separately, it may alleviate the excessive variation at different nodes in the circuit due to the large variation of voltage, achieving more balanced compensation.

In some embodiments, compensation for brightness changes may also be achieved by adjusting the voltage difference between the power supply voltage ELVDD and the reference voltage ELVSS. For example, when switching from the first frequency to the second frequency, for the next N consecutive frames, at least one of the power supply voltage and reference voltage for each the first to n^{th} hold frames may be adjusted so that the absolute difference between the power supply voltage and reference voltage for each of the first to n^{th} hold frames is smaller than the absolute difference between the power supply voltage and the reference voltage for the refresh frame. In some embodiments, the power supply voltage and reference voltage for the first to n^{th} hold frames may be adjusted equally, so that the factor by which the absolute difference between the power supply voltage and the reference voltage is adjusted is twice of the factor by which the power supply voltage and the reference voltage are adjusted. Taking switching from 120 Hz to 30 Hz as an example, for the next four consecutive frames, the first frame is a refresh frame, and the second to fourth frames are hold frames. The absolute difference between the power supply voltage ELVDD and the reference voltage ELVSS for each of the second and third frames may be adjusted relative to the first frame by a factor. The factor is less than 0.15V, for example, it may be less than or equal to 0.1V. In some embodiments, ELVDD may be adjusted by a factor of ΔV/2, and ELVSS may be adjusted by a factor of ΔV/2, so that a total factor of ΔV is obtained, achieving a more balanced variation. Like the adjustment of other driving signals, different adjustment factors may be employed based on different display brightness values. The larger the DBV, the greater the factor. It is also possible to set the adjustment factor for the second frame greater than the adjustment factor for the third frame, which will not be repeated here.

Under the same driving signal timing and voltage setting, brightness increases as the voltage (also known as cross voltage) between the first electrode and second electrode of the light-emitting element EL increases; and decreases as the cross voltage decreases. Generally, the power supply voltage ELVDD is about 5V, for example, 4.6V. The reference voltage ELVSS varies with the brightness level. The higher the brightness, the greater the amplitude. When switching from high frequency to low frequency, the cross voltage of the light-emitting element EL may be reduced by reducing the absolute difference between the power supply voltage ELVDD and the reference voltage ELVSS, thereby compensating for instantaneous brightness increase caused by frequency switching. On the contrary, when switching from low frequency to high frequency, the instantaneous decrease in brightness caused by frequency switching may be compensated for by increasing the absolute difference between the power supply voltage ELVDD and the reference voltage ELVSS.

According to the embodiments of the present disclosure, the power supply voltage ELVDD and the reference voltage ELVSS may be generated by the power supply circuit. The driving circuit may adjust the power supply voltage ELVDD and the reference voltage ELVSS by controlling the power supply circuit.

Although the above embodiments illustrate switching from 120 Hz to 30 Hz as an example, the embodiments of the present disclosure are not limited to this. The embodiments of the present disclosure are applicable to switching various frequencies, for example, when switching frequency downwards at 120 Hz, there are various switching schemes such as 120/60 Hz, 120/40 Hz, 120/30 Hz, 120/20 Hz, 120/10 Hz, 120/5 Hz, 120/1 Hz, etc. The ratios of the refresh frame to the hold frame vary for different schemes. If the frequency is reduced from 120 Hz to 10 Hz, 12 frames may be taken as a group for one cycle, with 11 frames being hold frame and one frame being refresh frame. For different switching schemes, brightness difference generally occurs between the first hold frame (which is actually the second frame due to the existence of the refresh frame) and the second hold frame (which is actually the third frame due to the existence of the refresh frame). Therefore, for other switching frequencies, compensation may be applied to just the first and second hold frames, while the fourth frame and the frames following the fourth frame may be set in the same manner as the fourth frame. Specifically, when switching from 120 Hz to 60 Hz, there is only one refresh frame and one hold frame, so that the compensation is performed in the first hold frame without considering the second refresh frame.

The above embodiments illustrate the adjustment methods of various driving signals by switching from high frequency to low frequency. For switching from low frequency to high frequency, for the same reason, there may be an instantaneous decrease in brightness. To this end, a reverse adjustment may be performed to compensate for the decrease in brightness. Similarly, compensation for brightness decrease may be achieved by adjusting at least one of the light-emitting control signal, the first initial voltage, the second initial voltage, the power supply voltage, and the reference voltage.

For example, in response to an instruction of switching from the second frequency to the first frequency, the driving circuit adjusts the driving signal for the next refresh frame relative to the driving signal for the last hold frame in the current group of N consecutive frames. For example, the driving signal for the next one or more refresh frames may be adjusted by at least one of the following: adjusting the effective level duration of the light-emitting control signal for the next refresh frame, so that the effective level duration of the light-emitting control signal for the refresh frame is greater than the effective level duration of the light-emitting control signal for the hold frame; adjusting the first initial voltage of the next refresh frame so that the first initial voltage for the next refresh frame is negatively biased relative to the first initial voltage for the hold frame; adjusting the second initial voltage for the next refresh frame so that the second initial voltage for the next refresh frame is positively biased relative to the second initial voltage of the hold frame; adjusting at least one of the power signal and reference signal of the next refresh frame so that the absolute difference between the power signal and reference signal of the next refresh frame is greater than the absolute difference between the power signal and reference signal of the hold frame. Like switching from high frequency to low frequency, the adjustment factor may vary according to the brightness, and the higher the brightness, the greater the factor. After switching to low frequency, since all frames are refresh frames, compensation for brightness decrease may be achieved by adjusting the driving signals of the first few (such as the first two) refresh frames. The adjustment factor of the first refresh frame may be greater than that of the second refresh frame. The specific adjustment method and adjustment factor may refer to the those described in switching from high frequency to low frequency, which will not be repeated here.

The display device of the embodiments of the present disclosure may be implemented in any electronic device with display function. Examples of electronic devices include but are not limited to, for example, smartphones, mobile phones, video phones, e-book readers, desktop computers (PCs), laptops, netbooks, personal digital assistants (PDAs), portable multimedia players (PMPs), digital audio players, mobile medical devices, cameras, wearable devices (such as headsets, electronic clothing, electronic bracelets, electronic necklaces, electronic accessories, electronic tattoos, or smartwatches), etc. The electronic device according to the embodiments of the present disclosure may also be an AR/VR display device, such as a helmet display, a stereoscopic display mirror, and a glasses display. According to the embodiments of the present disclosure, electronic devices may also be near eye devices that replace optical structures with digital displays, such as electronic telescopes, electron microscopes, medical endoscopes, and other professional devices with similar near eye display requirements.

According to the embodiments of the present disclosure, the electronic device may also be an intelligent household appliance that includes a display function. For example, smart home appliances may be televisions, digital video disc (DVD) players, speakers, refrigerators, air conditioners, vacuum cleaners, ovens, microwaves, washing machines, dryers, air purifiers, set-top boxes, television (TV) boxes, game consoles, electronic dictionaries, electronic keys, cameras, video frames, etc.

According to the embodiments of the present disclosure, electronic devices may also be medical devices (such as magnetic resonance angiography (MRA) devices, magnetic resonance imaging (MRI) devices, computed tomography (CT) devices, imaging devices, or ultrasound devices), navigation devices, global positioning system (GPS) receivers, event data recorders (EDRs), flight data recorders (FDRs), automotive information and entertainment devices, navigation electronic devices (such as navigation devices, gyroscopes or compasses), aviation electronic devices, safety devices, industrial or consumer robots, ATMs, points of sale (POS), etc.

According to the embodiments of the present disclosure, electronic devices may also include furniture with display functions, parts of buildings/structures, electronic bulletin boards, electronic signature receiving devices, projectors, various measuring devices (such as water meters, electricity meters, gas meters, or electromagnetic wave measuring devices), etc. According to some embodiments, electronic devices may be any combination of the aforementioned devices. Furthermore, electronic devices according to various embodiments may be flexible devices. In addition, those skilled in the art should be aware that electronic devices according to various embodiments of the present disclosure are not limited to the aforementioned devices.

The embodiments of the present disclosure also provide a method of driving a display device. The method includes: in a case of displaying at a first frequency, taking each frame as a refresh frame, generating a driving signal for the refresh frame, and applying the generated driving signal for the refresh frame and a data signal to a plurality of sub-pixels of the display device, so that the plurality of sub-pixels receive the data signal and emit light, under control of the driving signal for the refresh frame; and in a case of displaying at a second frequency, taking N consecutive frames comprising a refresh frame and N−1 hold frames as a group, generating a driving signal for the refresh frame in the group and a driving signal for each of the N−1 hold frames in the group, and applying the generated driving signal for the refresh frame and the generated driving signal for each of the hold frames to the plurality of sub-pixels, so that the plurality of sub-pixels receive the data signal and emit light under control of the driving signal for the refresh frame, and maintain the received data signal and emit light under control of the driving signal for each of the hold frames, where N is a ratio of the first frequency to the second frequency, and N is an integer greater than 1. The method also includes: adjusting the driving signal for each of 1^{st} to n^{th} hold frames in a next group of N consecutive frames relative to the driving signal for the refresh frame in the next group of N consecutive frames, in response to receiving an instruction of switching from the first frequency to the second frequency, where 1≤n≤N−1.

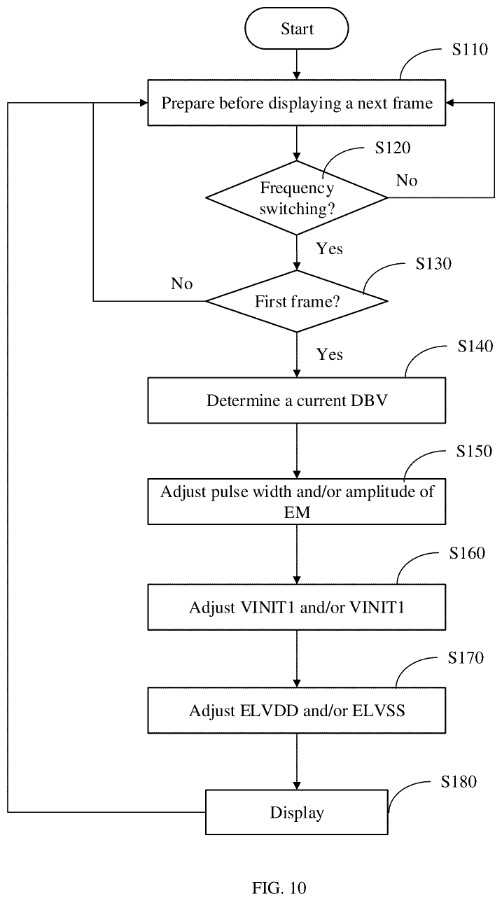

FIG. 10 shows a schematic flowchart of a method of driving a display device according to embodiments of the present disclosure. This method is applicable to any display device of the above embodiments.

In step S110, preparation is performed before displaying the next frame.

In step S120, it is determined whether to perform frequency switching. If yes, the process proceeds to step S130 is performed; otherwise, the process returns to step S110.

In step S130, it is determined whether a next frame is a first frame after the frequency switching. If yes, the process proceeds to step S140; otherwise, the process returns to step S110.

In step S140, a current display brightness value (DBV) is determined.

In step S150, at least one of a pulse width and an amplitude of the light-emitting control signal EM is adjusted based on the current DBV.

The pulse width (such as low level duration) of the light-emitting control signal EM in one or more consecutive frames may be adjusted according to the above embodiments. Taking switching from 120 Hz to 30 Hz as an example, the composition of the next N consecutive frames according to the proportion of frequency switching is determined. For example, it is determined that the first frame of the next four consecutive frames is a refresh frame and the second to fourth frames of the next four consecutive frames are hold frames. Then, the adjustment factor of the EM pulse width for each frame corresponding to the current DBV is determined based on a mapping table, e.g. 0 for the first frame, −12 for the second frame, −4 for the third frame, and 0 for the fourth frame. Then, for the next four consecutive frames, the pulse width of the light-emitting control signal EM for each of the first frame (refresh frame) and the fourth frame (last hold frame) may be kept identical to that for the refresh frame at 120 Hz, the pulse width of the light-emitting control signal EM for the second frame (first hold frame) may be reduced by 12, and the pulse width of the light-emitting control signal EM in the third frame (second hold frame) may be reduced by 4. No adjustments may be performed for frames following the fourth frame. Conversely, when switching from low frequency to high frequency, such as from 30 Hz to 120 Hz, the next group of N consecutive frames will all be refresh frames. Adjustment factor corresponding to the current DBV may be determined for each of the first two refresh frames, and then the pulse width of the light-emitting control signal for each of the first two refresh frames may be adjusted by respective adjustment factor. For the third and subsequent frames, no adjustments may be performed.

Similarly, it is also possible to adjust the amplitude of the light-emitting control signal EM (such as the low level value) in the same manner as that described in the above embodiments, which will not be repeated here.

In step S160, at least one of the first initial voltage VINIT and the second initial voltage VINIT2 are adjusted based on the current DBV. The first initial voltage VINIT and/or second initial voltage VINIT2 of one or more consecutive frames in the following the plurality of consecutive frames may be adjusted according to the above embodiments, which will not be repeated here.

In step S170, at least one of the power supply voltage ELVDD and reference voltage ELVSS is adjusted based on the current DBV. For one or more of the next consecutive frames, the power supply voltage ELVDD and/or reference voltage ELVSS may be adjusted in the same manner as that described in the above embodiments, which will not be repeated here.

At this point, compensation for various driving signals has been completed.

In step S180, the compensated driving signal is used for display. For example, the driving control circuit may control the gate driving circuit to generate the gate driving signal and the compensated light-emitting control signal, control the power supply circuit to apply the compensated power voltage and the reference voltage to each sub-pixel, apply the compensated first initial voltage, the compensated second initial voltage, and the compensated third initial voltage to various sub-pixels, and apply the data signal to various sub-pixels. Each sub-pixel displays based on the data signal under control of various driving signals.

Although the above embodiments describe various steps of the method in a specific order, the embodiments of the present disclosure are not limited to this. For example, the order of performing steps S140 to S170 may be set as desired, so that adjustments of various driving signals may be performed in any desired order. For example, steps S150, S160, S140 and S170 may be performed in this order, or in other appropriate order.

Those skilled in the art may understand that embodiments described above are exemplary, and those skilled in the art may improve them. The structures described in various embodiments can be freely combined without structural or principle conflicts.

After elaborating on preferred embodiments of the present disclosure, those skilled in the art can clearly understand that various changes and approaches can be made without departing from the scope and spirit of the appended claims, and the present disclosure is not limited to the implementation methods of the exemplary embodiments cited in the specification.

1. A display device, comprising:
a plurality of sub-pixels arranged in an array comprising rows and columns; and
a driving circuit connected to the plurality of sub-pixels, wherein the driving circuit is configured to:
in a case of displaying at a first frequency, take each frame as a refresh frame, generate a driving signal for the refresh frame, and apply the generated driving signal for the refresh frame and a data signal to the plurality of sub-pixels of the display device, so that the plurality of sub-pixels receive the data signal and emit light, under control of the driving signal for the refresh frame; and
in a case of displaying at a second frequency, take N consecutive frames comprising a refresh frame and N−1 hold frames as a group, generate, for each group, a driving signal for the refresh frame in the group and a driving signal for each of the N−1 hold frames in the group, and apply the generated driving signal for the refresh frame and the generated driving signal for each of the hold frames to the plurality of sub-pixels, so that the plurality of sub-pixels receive the data signal and emit light under control of the driving signal for the refresh frame, and maintain the received data signal and emit light under control of the driving signal for each of the hold frames, wherein N is a ratio of the first frequency to the second frequency, and N is an integer greater than 1;
wherein the driving circuit is further configured to adjust the driving signal for each of 1^{st} to n^{th} hold frames in a next group of N consecutive frames relative to the driving signal for the refresh frame in the next group of N consecutive frames, in response to receiving an instruction of switching from the first frequency to the second frequency, wherein 1≤n≤N−1.

2. The display device of claim 1, wherein the driving circuit is configured to adjust the driving signal for each of the 1^{st} to n^{th} hold frames by:
adjusting the driving signal for each of the 1^{st} to n^{th} hold frames according to a current display brightness value of the display device by a factor, wherein the larger the display brightness value, the greater the factor.

3. The display device of claim 1, wherein the driving circuit is configured to adjust the driving signal for each of the 1^{st} to n^{th} hold frames by:
adjusting the driving signal for each of the 1^{st} to n^{th} hold frames by a factor, such that the factor by which the driving signal for an n1^{th} hold frame is adjusted is greater than the factor by which the driving signal for an n2^{th} hold frame is adjusted, wherein 1≤n1≤n2≤n.

4. The display device of claim 1, wherein the driving signal comprises at least one of a light emitting control signal, a first initial voltage, a second initial voltage, a power supply voltage and a reference voltage, wherein the light emitting control signal is configured to control the sub-pixels to emit light, the first initial voltage is configured to initialize a voltage of a first electrode of a light emitting element of the sub-pixels, the second initial voltage is configured to initialize a voltage of an input terminal of a driving transistor of the sub-pixels for driving the light emitting element, and the power supply voltage and the reference voltage are configured to supply power to the sub-pixels.

5. The display device of claim 4, wherein the driving signal comprises a light emitting control signal, and the driving circuit is configured to adjust the driving signal for each of the 1^{st} to n^{th} hold frames by:
adjusting a waveform parameter of the light emitting control signal for each of the 1^{st} to n^{th} hold frames relative to a waveform parameter of the light emitting control signal for the refresh frame, so that the waveform parameter of the light emitting control signal for each of the 1^{st} to n^{th} hold frames is adjusted to be smaller than the waveform parameter of the light emitting control signal for the refresh frame, wherein the waveform parameter comprises at least one of an effective level duration and an amplitude.

6. The display device of claim 5, wherein in a case that the display brightness value is in a range of 200 nits to 900 nits, the effective level duration of the light emitting control signal for the hold frame is adjusted by a factor of 4 to 12 rows of sub-pixels or a factor of 4 to 12 pulses.

7. The display device of claim 6, wherein in the case that the display brightness value is in a range of 200 nits to 900 nits, the effective level duration of the light emitting control signal for the first hold frame is adjusted by a factor of 8 to 12 rows of sub-pixels or a factor of 8 to 12 pulses, and the effective level duration of the light emitting control signal for the second hold frame is adjusted by a factor of 4 to 8 rows of sub-pixels or a factor of 4 to 8 pulses.

8. The display device of claim 5, wherein in a case that the display brightness value is in a range of 10 nits to 200 nits, the effective level duration of the light emitting control signal for the hold frame is adjusted by a factor of 4 to 8 rows of sub-pixels or a factor of 4 to 8 pulses.

9. The display device of claim 8, wherein in the case that the display brightness value is in a range of 10 nits to 200 nits, the effective level duration of the light emitting control signal for the first hold frame is adjusted by a factor of 4 to 8 rows of sub-pixels or a factor of 4 to 8 pulses, and the effective level duration of the light emitting control signal for the second hold frame is adjusted by a factor of 0 to 4 rows of sub-pixels or a factor of 0 to 4 pulses.

10. The display device of claim 4, wherein the driving signal comprises the first initial voltage and the driving circuit is configured to adjust the driving signal for each of the 1^{st} to n^{th} hold frames by:
adjusting the first initial voltage for an (N−1)^{th} hold frame among the N−1 hold frames, so that the first initial voltage for the (N−1)^{th} hold frame is positively biased relative to the first initial voltage for the refresh frame; and
adjusting the first initial voltage for each of the 1^{st} to n^{th} hold frames among the N−1 hold frames, so that the first initial voltage for each of the 1^{st} to n^{th} hold frames is positively biased relative to the first initial voltage for the (N−1)^{th} hold frame.

11. The display device of claim 4, wherein the driving signal comprises the second initial voltage, and the driving circuit is configured to adjust the driving signal for each of the 1^{st} to n^{th} hold frames by:
adjusting the second initial voltage for an (N−1)^{th} hold frame among the N−1 hold frames, so that the second initial voltage for the (N−1)^{th} hold frame is positively biased relative to the second initial voltage for the refresh frame; and
adjusting the second initial voltage for each of the 1^{st} to n^{th} hold frames among the N−1 hold frames, so that the second initial voltage for each of the 1^{st} to n^{th} hold frames is negatively biased relative to the second initial voltage for the (N−1)^{th} hold frame.

12. The display device of claim 4, wherein the driving signal comprises at least one of the power supply voltage and the reference voltage, and the driving circuit is configured to adjust the driving signal for each of the 1^{st} to n^{th} hold frames by:
adjusting at least one of the power supply voltage and the reference voltage for each of the 1^{st} to n^{th} hold frames, so that an absolute difference between the power supply voltage and the reference voltage for each of the 1^{st} to n^{th} hold frames is less than an absolute difference between the power supply voltage and the reference voltage for the refresh frame.

13. The display device of claim 12, wherein the driving circuit is configured to adjust the driving signal for each of the 1^{st} to n^{th} hold frames by:
equally adjusting the power supply voltage and the reference voltage for each of the 1^{st} to n^{th} hold frames, so that the factor by which the absolute difference between the power supply voltage and the reference voltage is adjusted is twice the factor by which the power supply voltage and the reference voltage are adjusted;
wherein, in a case of N=2, n=1; and in a case that N is greater than 2, n=2.

14. (canceled)

15. The display device of claim 1, wherein the driving circuit is further configured to adjust the driving signal for next one or more refresh frames relative to the driving signal for the last hold frame in a current group of N consecutive frames, in response to receiving an instruction of switching from the second frequency to the first frequency; and
wherein the driving signal comprises at least one of a light emitting control signal, a first initial voltage, a second initial voltage, a power supply voltage and a reference voltage, and the driving circuit is configured to adjust the driving signal for the next one or more refresh frames by at least one of:
adjusting an effective level duration of the light emitting control signal for the next one or more refresh frames, so that the effective level duration of the light emitting control signal for the refresh frame is greater than the effective level duration of the light emitting control signal for the hold frame;
adjusting the first initial voltage for the next one or more refresh frames, so that the first initial voltage for the next one or more refresh frames is negatively biased relative to the first initial voltage for the hold frame;
adjusting the second initial voltage for the next one or more refresh frames, so that the second initial voltage for the next one or more refresh frames is positively biased relative to the second initial voltage for the hold frame; and
adjusting at least one of the power supply signal and the reference signal for the next one or more refresh frames, so that an absolute difference between the power supply signal and the reference signal for the next one or more refresh frames is greater than an absolute difference between the power supply signal and the reference signal for the hold frame.

16. (canceled)

17. The display device of claim 1, wherein the driving circuit comprises:
gate driving circuit connected to the plurality of sub-pixels, wherein the gate driving circuit is configured to generate a gate driving signal and a light emitting control signal; and
a driving control circuit connected to the gate driving circuit and the plurality of sub-pixels, wherein the driving control circuit is configured to control the gate driving circuit to generate the gate driving signal and the light emitting control signal, apply the data signal to the plurality of sub-pixels, and adjust the light emitting control signal;
wherein the driving control circuit is further configured to provide a first initial voltage and/or a second initial voltage, and adjust the first initial voltage and/or the second initial voltage; and
wherein the driving circuit further comprises a power supply circuit for providing a power supply voltage and a reference voltage to the sub-pixel, and the driving control circuit is further configured to control the power supply circuit to adjust at least one of the power supply voltage and the reference voltage.

18-19. (canceled)

20. The display device of claim 1, wherein the sub-pixel comprises a pixel driving circuit and a light emitting element, and the pixel driving circuit comprises:
a driving sub-circuit comprising a control terminal, an input terminal and an output terminal;
a storage sub-circuit connected between the control terminal of the driving sub-circuit and a power supply signal terminal for receiving a power supply voltage;
an input sub-circuit connected to the input terminal of the driving sub-circuit, wherein the input sub-circuit is configured to provide a data signal to the input terminal of the driving sub-circuit under control of a first gate driving signal;
an input control sub-circuit connected between the output terminal of the driving sub-circuit and the control terminal of the driving sub-circuit, wherein the input control sub-circuit is configured to electrically connect the output terminal of the driving sub-circuit to the control terminal of the driving sub-circuit under control of a second gate driving signal;
a light emitting control sub-circuit connected between the driving sub-circuit and the power supply signal terminal, and between the driving sub-circuit and the light emitting element, wherein the light emitting control sub-circuit is configured to conduct a path from the power supply signal terminal to the light emitting element through the driving sub-circuit under control of the light emitting control signal; and
an initialization sub-circuit connected to the input terminal of the driving sub-circuit, the output terminal of the driving sub-circuit and a first electrode of the light emitting element, wherein the initialization sub-circuit is configured to initialize a voltage at each of the input terminal of the driving sub-circuit, the output terminal of the driving sub-circuit and the first electrode of the light emitting element, wherein a second electrode of the light emitting element is connected to a reference signal terminal for receiving a reference voltage.

21. The display device of claim 20, wherein the driving sub-circuit comprises a driving transistor, a gate of the driving transistor serves as the control terminal of the driving sub-circuit, a first electrode of the driving transistor serves as the input terminal of the driving sub-circuit, and a second electrode of the driving transistor serves as the output terminal of the driving sub-circuit;
wherein the storage sub-circuit comprises a capacitor, a first electrode of the capacitor is connected to the control terminal of the driving sub-circuit, and a second electrode of the storage sub-circuit is connected to the power supply signal terminal;
wherein the input sub-circuit comprises a first transistor, a gate of the first transistor is configured to receive a first gate driving signal, a first electrode of the first transistor is configured to receive the data signal, and a second electrode of the first transistor is connected to the input terminal of the driving sub-circuit;
wherein the input control sub-circuit comprises a second transistor, a gate of the second transistor is configured to receive a second gate driving signal, a first electrode of the second transistor is connected to the output terminal of the driving sub-circuit, and a second electrode of the second transistor is connected to the control terminal of the driving sub-circuit;
wherein the light emitting control sub-circuit comprises a third transistor and a fourth transistor, wherein a gate of the third transistor is configured to receive a light emitting control signal, a first electrode of the third transistor is connected to the power supply signal terminal, and a second electrode of the third transistor is connected to the input terminal of the driving sub-circuit; and wherein a gate of the fourth transistor is configured to receive a light emitting control signal, a first electrode of the fourth transistor is connected to the output terminal of the driving sub-circuit, and a second electrode of the fourth transistor is connected to the first electrode of the light emitting element; and
wherein the initialization sub-circuit comprises a fifth transistor, a sixth transistor and a seventh transistor, wherein a gate of the fifth transistor is configured to receive a first reset signal, a first electrode of the fifth transistor is configured to receive a first initial voltage, and a second electrode of the fifth transistor is connected to the first electrode of the light emitting element; wherein a gate of the sixth transistor is configured to receive the first reset signal, a first electrode of the sixth transistor is configured to receive a second initial voltage, and a second electrode of the sixth transistor is connected to the input terminal of the driving sub-circuit; and wherein a gate of the seventh transistor is configured to receive a second reset signal, a first electrode of the seventh transistor is configured to receive a third initial voltage, and a second electrode of the seventh transistor is connected to the output terminal of the driving sub-circuit.

22-25. (canceled)

26. A method of driving a display device, comprising:
in a case of displaying at a first frequency, taking each frame as a refresh frame, generating a driving signal for the refresh frame, and applying the generated driving signal for the refresh frame and a data signal to a plurality of sub-pixels of the display device, so that the plurality of sub-pixels receive the data signal and emit light, under control of the driving signal for the refresh frame; and
in a case of displaying at a second frequency, taking N consecutive frames comprising a refresh frame and N−1 hold frames as a group, generating for each group a driving signal for the refresh frame in the group and a driving signal for each of N−1 hold frames in the group, and applying the generated driving signal for the refresh frame and the generated driving signal for each of the hold frames to the plurality of sub-pixels, so that the plurality of sub-pixels receive the data signal and emit light under control of the driving signal for the refresh frame, and maintain the received data signal and emit light under control of the driving signal for each of the hold frames, wherein N is a ratio of the first frequency to the second frequency, and N is an integer greater than 1;
wherein the method further comprises: adjusting the driving signal for each of 1^{st} to n^{th} hold frames in a next group of N consecutive frames relative to the driving signal for the refresh frame in the next group of N consecutive frames, in response to receiving an instruction of switching from the first frequency to the second frequency, wherein 1≤n≤N−1.

27. The method of claim 26, wherein the adjusting the driving signal for each of 1^{st} to n^{th} hold frames in the next group of N consecutive frames relative to the driving signal for the refresh frame in the next group of N consecutive frames comprises: adjusting the driving signal for each of the 1^{st} to n^{th} hold frames according to a current display brightness value of the display device by a factor, wherein the larger the display brightness value, the greater the factor; and
wherein the adjusting the driving signal for each of 1st to nth hold frames in the next group of N consecutive frames relative to the driving signal for the refresh frame in the next group of N consecutive frames comprises: adjusting the driving signal for each of the 1st to n^{th} hold frames such that the factor by which the driving signal for an n1th hold frame is adjusted is greater than the factor by which the driving signal for an n2^{th} hold frame is adjusted, wherein 1≤n1≤n2≤n.

28. (canceled)

29. The method of claim 26, wherein the driving signal comprises at least one of a light emitting control signal, a first initial voltage, a second initial voltage, a power supply voltage and a reference voltage, wherein the light emitting control signal is configured to control the sub-pixel to emit light, the first initial voltage is configured to initialize a voltage of a first electrode of a light emitting element of the sub-pixel, the second initial voltage is configured to initialize a voltage of an input terminal of a driving transistor of the sub-pixel for driving the light emitting element, and the power supply voltage and the reference voltage are configured to supply power to the sub-pixel;
wherein in a case of N=2, n=1; and in a case that N is greater than 2, n=2;
wherein the method further comprises: adjusting the driving signal for next one or more refresh frames relative to the driving signal for the last hold frame in a current group of N consecutive frames, in response to receiving an instruction of switching from the second frequency to the first frequency; and
wherein the driving signal comprises at least one of a light emitting control signal, a first initial voltage, a second initial voltage, a power supply voltage and a reference voltage, and the adjusting the driving signal for next one or more refresh frames relative to the driving signal for the last hold frame in the current group of N consecutive frames comprises at least one of:
adjusting an effective level duration of the light emitting control signal for the next one or more refresh frames, so that the effective level duration of the light emitting control signal for the next one or more refresh frames is greater than the effective level duration of the light emitting control signal for the last hold frame;
adjusting the first initial voltage for the next one or more refresh frames, so that the first initial voltage for the next one or more refresh frames is negatively biased relative to the first initial voltage for the last hold frame;
adjusting the second initial voltage for the next one or more refresh frames, so that the second initial voltage for the next one or more refresh frames is positively biased relative to the second initial voltage for the last hold frame; and
adjusting at least one of the power supply signal and the reference signal for the next one or more refresh frames, so that an absolute difference between the power supply signal and the reference signal for the next one or more refresh frames is greater than an absolute difference between the power supply signal and the reference signal for the last hold frame.

30-32. (canceled)
